(19) United States
(12) Patent Application Publication
(10) Pub. No.: US 2007/0024802 A1
(43) Pub. Date: Feb. 1, 2007

(54) Liquid crystal display

(76) Inventor: Soon-Wook Kwon, Suwon-si (KR)

Correspondence Address: CHRISTIE, PARKER & HALE, LLP, PO BOX 7068, PASADENA, CA, 91109-7068, US

(21) Appl. No.: 11/364,608

(22) Filed: Feb. 27, 2006

(30) Foreign Application Priority Data
Apr. 27, 2005 (KR) 2005-35198

(51) Int. Cl. C09K 19/02

(52) U.S. Cl. 349/177

(57) ABSTRACT

The present invention is an OCB mode liquid crystal display for improving transition voltage, reliability and driving margin by restricting birefringence, dielectric constant anisotropy, K11, K33 and viscosity of liquid crystals to the optimum values in the OCB mode liquid crystal display, where K11 represents an elastic coefficient of a splay phase, and K33 represents an elastic coefficient of a bend phase.

### CROSS REFERENCE

This application claims the benefit of Korean Patent Application No. 2005-35198, filed on Apr. 27, 2005, the disclosure of which is hereby incorporated herein by reference in its entirety.

### FIELD OF THE INVENTION

The present invention relates to a liquid crystal display, more particularly, to an OCB mode liquid crystal device formed of liquid crystals having optimum value ranges of birefringence, dielectric constant anisotropy, K11, K33 and viscosity.

### BACKGROUND

Recently, flat panel displays such as liquid crystal displays have been attempting to solve the disadvantages of conventional displays such as cathode ray tubes for being heavy and large.

A liquid crystal display is generally used in wide variety of fields compared with other flat panel displays since the liquid crystal display has such as high resolution, being capable of displaying diverse colors, having high picture quality, and consuming less electric power.

The liquid crystal display uses difference of light transmittance caused by change of liquid crystal alignment. The display mode of the liquid crystal display can be divided into a polarization type display mode, a dispersion type display mode, an absorption type display mode and a reflection type display mode according to the use of the characteristics of light.

The polarization type display mode is divided into a TN (Twisted Nematic) type liquid crystal display, a ferroelectric type liquid crystal display and an ECB (Electrical Controlled Birefringence) type liquid crystal display. The dispersion type display mode is divided into a PDLC (Polymer Dispersed Liquid Crystal) type liquid crystal display, a DS (Dynamic Scattering) type liquid crystal display and a PSCT (Polymer Stabilized Cholesteric Texture) type liquid crystal display. The absorption type display mode includes a GH (Gust Host).

An OCB mode liquid crystal display is suggested to improve viewing angle and fast response speed in the ECB (Electrical Controlled Birefringence) type liquid crystal display.

However, the OCB mode liquid crystal display has disadvantages, such as problems in transition voltage, reliability and driving margin because properties of the liquid crystals such as birefringence, dielectric constant anisotropy, K11, K33 and viscosity are not optimized.

### SUMMARY OF THE INVENTION

Therefore, in order to solve the foregoing various demerits and problems of the prior art, it is an object of the present invention to provide optimized values of birefringence, dielectric constant anisotropy, K11, K33 and viscosity of OCB mode liquid crystals. K11 represents an elastic coefficient of splay phase, and K33 represents an elastic coefficient of bend phase. High elastic coefficients of K11 and K33 mean that there is a strong tendency to maintain the respective phases of K11 and K33.

In order to achieve the foregoing object, the present invention provides a liquid crystal display comprising: a first substrate on which a first electrode is formed; a second substrate which faces the first substrate, and on which a second electrode is formed; and a liquid crystal layer which is filled between the first electrode and the second electrode and has a birefringence of 0.160 to 0.180.

Furthermore, the present invention provides a liquid crystal display comprising: a first substrate on which a first electrode is formed; a second substrate which faces the first substrate, and on which a second electrode is formed; and a liquid crystal layer which is filled between the first electrode and the second electrode and has a dielectric constant anisotropy of 12 or more.

Furthermore, the present invention provides a liquid crystal display comprising: a first substrate on which a first electrode is formed; a second substrate which faces the first substrate, and on which a second electrode is formed; and a liquid crystal layer which is filled between the first electrode and the second electrode and has a K11 of 14 or less and a K33 of 12 to 16.

Furthermore, the present invention provides a liquid crystal display comprising: a first substrate on which a first electrode is formed; a second substrate which faces the first substrate, and on which a second electrode is formed; and a liquid crystal layer which is filled between the first electrode and the second electrode and has a pre-tilt angle of 4 to 10 degrees.

### BRIEF DESCRIPTION OF THE DRAWINGS

The above and other features and advantages of the present invention will become more apparent to those of ordinary skill in the art by describing in detail embodiments thereof with reference to the attached drawings in which:

FIG. 1 is a cross-sectional view of FS-LCD using an OCB liquid crystal mode;

FIG. 2A to FIG. 2C are graphs for showing birefringence of liquid crystals according to one embodiment of the present invention;

FIG. 3A to FIG. 3D are graphs for showing dielectric constant anisotropy of liquid crystals according to one embodiment of the present invention;

FIG. 4A and FIG. 4B are graphs for showing K11 and K33 of liquid crystals according to one embodiment of the present invention; and

FIG. 5A to FIG. 5C are graphs for showing pre-tilt angle of liquid crystals according to one embodiment of the present invention.

### DETAILED DESCRIPTION OF THE INVENTION

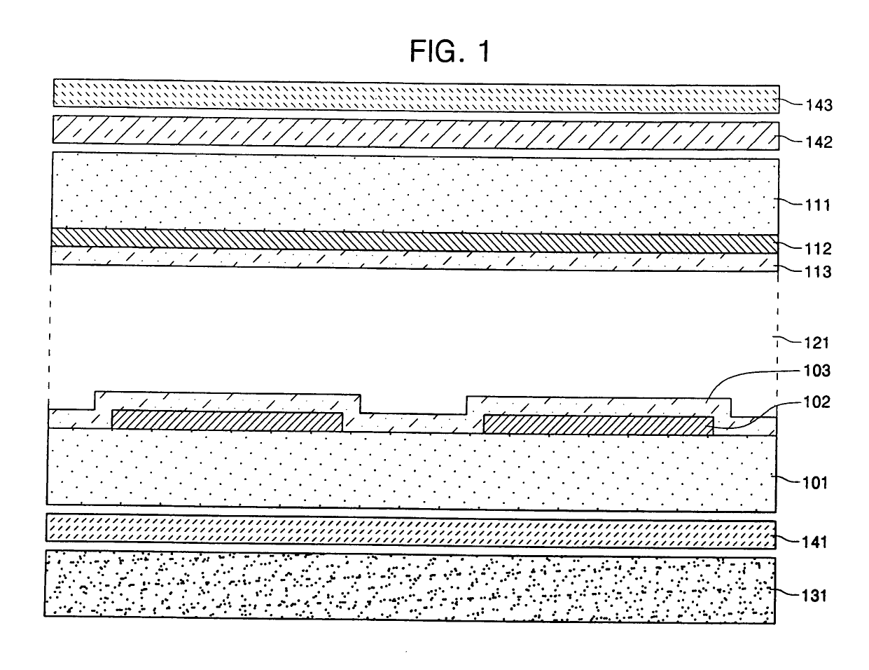

FIG. 1 illustrates a cross-sectional view of FS-LCD (Field Sequential-Liquid Crystal Display) using an Optically Compensated Bend (OCB) liquid crystal mode in one embodiment of the present invention. A shown, a first electrode 102 and a first alignment film 103 are positioned on a lower substrate 101 such as glass or plastic, and a second electrode 112 and a second alignment film 113 are positioned on an upper substrate 111 facing the lower substrate 101, wherein the first alignment film 103 and the second alignment film 113 are rubbed in the same direction.

Liquid crystals 121 of an OCB mode are filled between the lower substrate 101 and the upper substrate 111, more specifically, between the first alignment film 103 and the second alignment film 113.

A light source unit 131 is positioned under the lower substrate 101 to provide uniform light toward the lower substrate 101. The light source unit 131 generally includes a light source, a reflection plate, a light guide panel, a diffusion sheet, a prism sheet, etc. for uniformly supplying light generated from the light source.

A first polarizer 141 is positioned between the lower substrate 101 and the light source unit 131 for supplying a linearly polarized light to the lower substrate 101 by linearly polarizing light emitted from the light source unit 131.

Indices of refraction of light differentiate according to positions from which the liquid crystal display is seen by characteristics of the biaxial compensation film 142. These indices of refraction have different birefringence values in long axis direction and short axis direction of liquid crystals. Therefore, a phase difference is generated by the difference of the indices of refraction. Thus, a biaxial compensation film 142 is attached to an upper part of the upper substrate 111 to compensate the phase difference.

A second polarizer 143 is positioned on an upper part of the biaxial compensation film 142, wherein the second polarizer 143 is attached onto the upper part of the biaxial compensation film 142 such that the first polarizer 141 is perpendicular to a polarization axis.

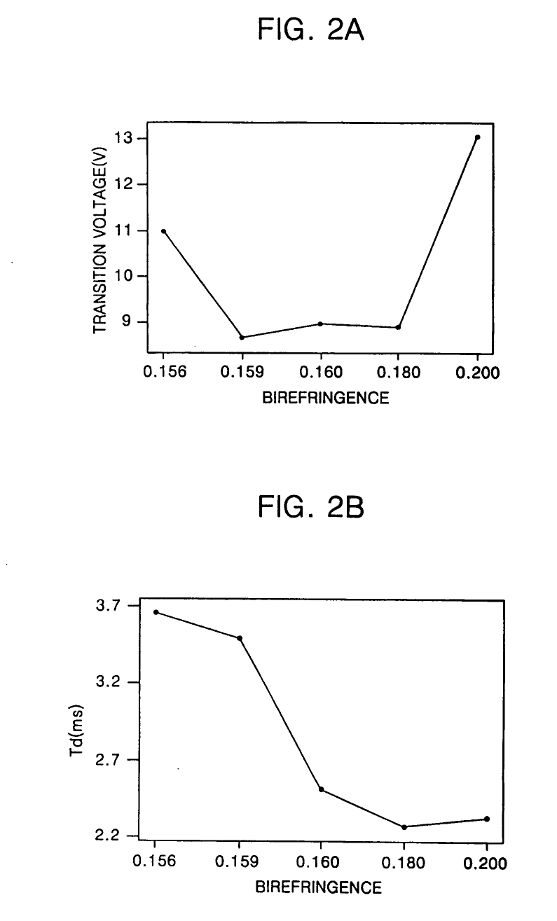

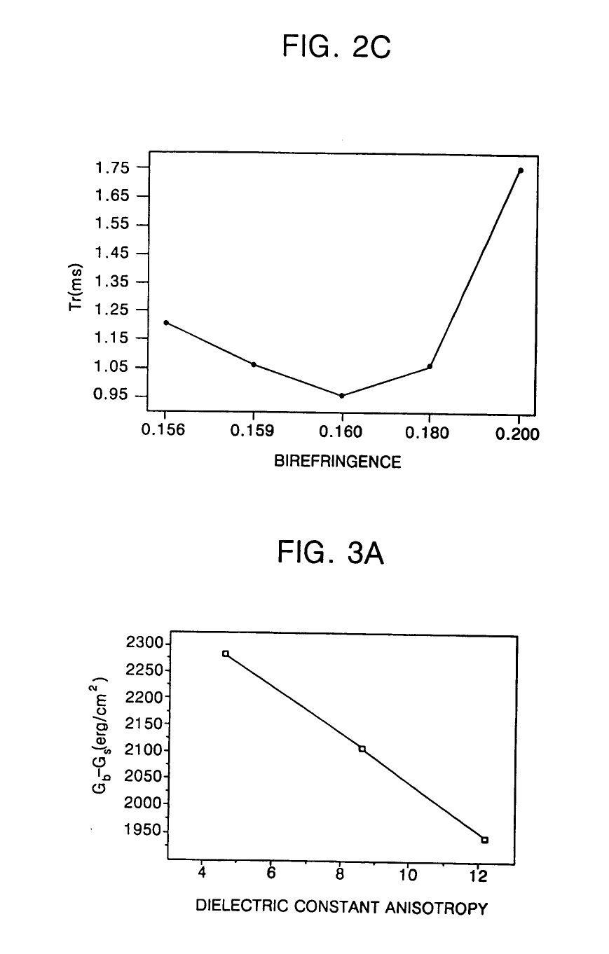

FIG. 2A to FIG. 2C are graphs for showing birefringence (Δn) of a liquid crystal according to one embodiment of the present invention.

FIG. 2A illustrates a relation of transition voltage to birefringence, FIG. 2B illustrates a relation of Td (ascent response time of liquid crystal) to birefringence, and FIG. 2C illustrates a relation of Tr (descent response time of liquid crystal) to birefringence.

The birefringence means that indices of refraction of light vibrated in a long axis direction of liquid crystal molecules and light vibrated perpendicularly to the long axis direction of the liquid crystal molecules are different from each other. That is, a quantified refraction index anisotropy. Therefore, the birefringence is a value indicating the polarization state of light that is transmitted from liquid crystals or the extent that a vibration direction of polarization is changed.

The transition voltage defines a voltage required for transition of OCB mode liquid crystals from a bend phase to a splay phase. Furthermore, the response time defines a time of (Tr+Td)/2 if an ascent time taken for reaching luminance of 90% from luminance of 10% is defined as Tr, and a descent time for reaching luminance of 10% from luminance of 90% is defined as Td.

Referring to FIG. 2A, the lower the transition voltage is, the more favorable an OCB mode liquid crystal display is, since the transition voltage is a voltage required for transition of liquid crystals from a splay phase to a bend phase. It can be seen in the graph of FIG. 2A that the transition voltage is lower in a specific birefringence range and, particularly, the transition voltage becomes 10 V or less in a birefringence range of 0.159 to 0.190.

Referring to FIG. 2B, the shorter the response time is, the better quality the images are in an OCB mode liquid crystal display. Td represents a time taken for changing liquid crystals into the down state, wherein when a birefringence is 0.160 or more, Td becomes 2.7 ms or less.

Referring to FIG. 2C, likewise, the shorter the response time Tr is, the better quality the images are in an OCB mode liquid crystal display. Tr represents a time taken for changing liquid crystals into the rising state, wherein when a birefringence is 0.180 or less, Tr becomes a low value, i.e., 1.25 ms or less.

Therefore, as shown in FIG. 2A to FIG. 2C, it is most preferable that the birefringence be in a range of 0.160 to 0.180, considering a relation of the transition voltage and the response time (Td and Tr).

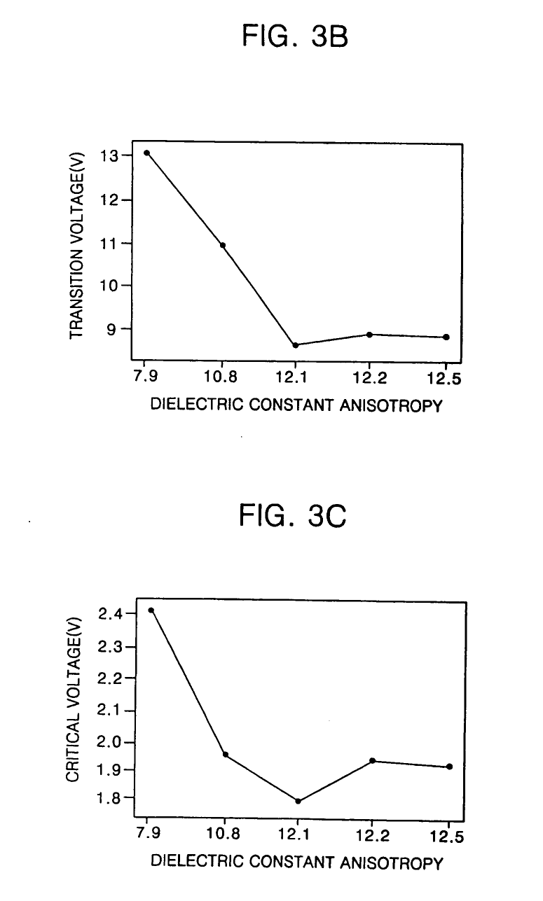

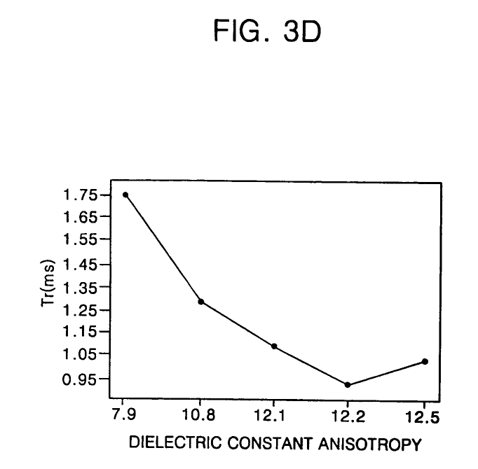

FIG. 3A to FIG. 3D are graphs for showing dielectric constant anisotropy (Δ∈) of liquid crystals according to one embodiment of the present invention. FIG. 3A is a graph illustrating a relation of Gibbs free energy difference (Gb-Gs) between bend phase and splay phase to dielectric constant anisotropy, FIG. 3B illustrates a relation of transition voltage to dielectric constant anisotropy, FIG. 3C illustrates a relation of critical voltage to dielectric constant anisotropy, and FIG. 3D illustrates a relation of Tr to dielectric constant anisotropy.

The dielectric constant anisotropy means a value obtained by quantifying a dielectric constant difference between a long axis direction of liquid crystal molecules and a direction perpendicular to the long axis direction. Owing to the dielectric constant anisotropy, a reaction direction of liquid crystals is changed according to the intensity of a voltage applied to a liquid crystal layer, and the amount of light transmitted by optical anisotropy. Furthermore, the critical voltage means the minimum voltage that prevents liquid crystals to change from bend phase to splay phase.

Referring to FIG. 3A, a difference between Gibbs energy of bend phase and Gibbs energy of splay phase is continuously reduced according to increase of the dielectric constant anisotropy. That is, the more the dielectric constant anisotropy is increased, the more the bend phase is stabilized compared with the splay phase.

Referring to FIG. 3B, it can be seen that if the dielectric constant anisotropy is increased beyond 12, the transition voltage is continuously decreased to about 10 V or less. It means that the voltage required for transition of splay phase of an OCB mode liquid crystals into bend phase of the OCB mode liquid crystals is lowered when the dielectric constant anisotropy is 12 or more.

Referring to FIG. 3C, it can be seen that if the dielectric constant anisotropy is 10.8 or more, the critical voltage is less than 2 V. It means that the voltage for preventing transition of liquid crystals in the bend phase into liquid crystals in the splay phase again should be maintained at 2 V or more. In other words, the voltage requirement for maintaining a liquid crystal display is low.

Referring to FIG. 3D, it can be seen that if the dielectric constant anisotropy is increased to 11 or more, the response time Tr is continuously decreased to about 1.25 ms or less. That is, it can be seen that speed of gradation display is increased in case that the dielectric constant anisotropy is 11 or more, wherein the Tr represents the time taken for reaching luminance of 90% from luminance of 10% during signal input as a data obtained by quantifying a rising time of liquid crystals in the response time of liquid crystals. Although the more the Tr is decreased, the easier the gradation display becomes, it is not possible to decrease the Tr indefinitely. Even though it depends on the individual eyes at what level the change of luminance is recognized, generally the change of luminance is rarely recognized when Tr is 1.25 ms or less.

Therefore, if 12 or more of the dielectric constant anisotropy is maintained such that dielectric constant in a long axis direction of liquid crystal molecules is different from dielectric constant in a direction perpendicular to the long axis direction of liquid crystal molecules, excellent characteristics are displayed in aspects of Gibbs energy difference between bend phase and splay phase, transition voltage, critical voltage and response speed/time.

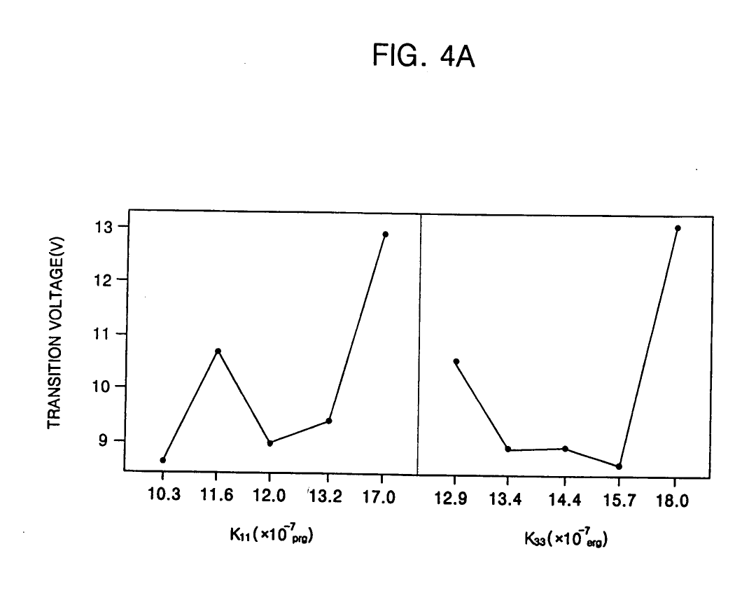

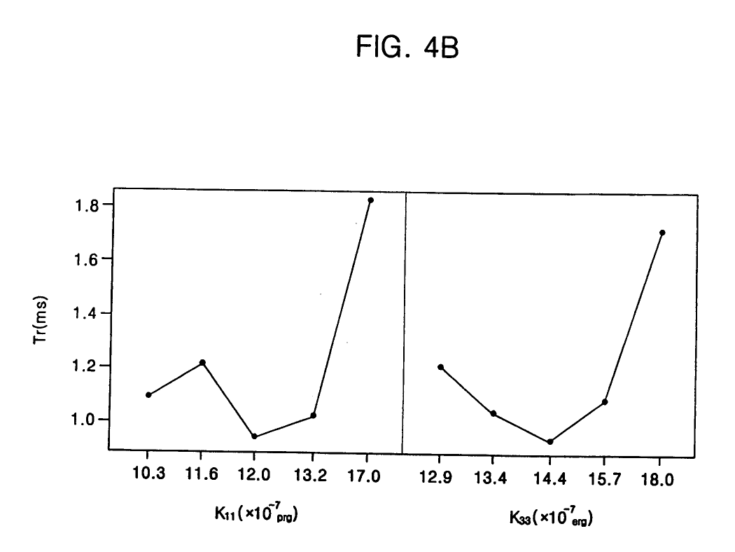

FIG. 4A and FIG. 4B are graphs for showing K11 and K33 of liquid crystals according to one embodiment of the present invention. FIG. 4A represents the relation of transition voltage to K11 and K33, and FIG. 4b represents the relation of Tr to K11 and K33. K11 represents an elastic coefficient of splay phase, and K33 represents an elastic coefficient of bend phase. High elastic coefficients of K11 and K33 mean that there is a strong tendency to maintain the respective phases of K11 and K33.

Referring to FIG. 4A, it can be seen that the transition voltage is about 11 V or less, when K11 value of OCB mode liquid crystals is 14 or less. The transition voltage is rapidly increased when the K11 value of OCB mode liquid crystals is 14 or more. Likewise, the transition voltage has a value of about 11 V or less when K33 value of OCB mode liquid crystals is 12 to 16. The transition voltage is rapidly increased when the K33 value of OCB mode liquid crystals is less than 12 or more than 16. Therefore, it is preferable that the K11 value is 14 or less, and the K33 value is 12 to 16 in the aspect of the transition voltage.

Referring to FIG. 4B, a response time of liquid crystals is decreased resulting in deterioration of gradation characteristics in a liquid crystal display, because Tr is about 1.2 ms or less when a K11 value of OCB mode liquid crystals is 14 or less. Tr is then rapidly increased when the K11 value of OCB mode liquid crystals is more than 14. Furthermore, the response time of OCB mode liquid crystals is also decreased because Tr is about 1.25 ms or less when a K33 value of OCB mode liquid crystals is 12 to 16, and the Tr is rapidly increased when the K33 value of OCB mode liquid crystals is less than 12 or more than 16.

Therefore, it is preferable that the K11 value is 14 or less, and the K33 value is 12 to 16, considering the transition voltage and the Tr in the response time of liquid crystals.

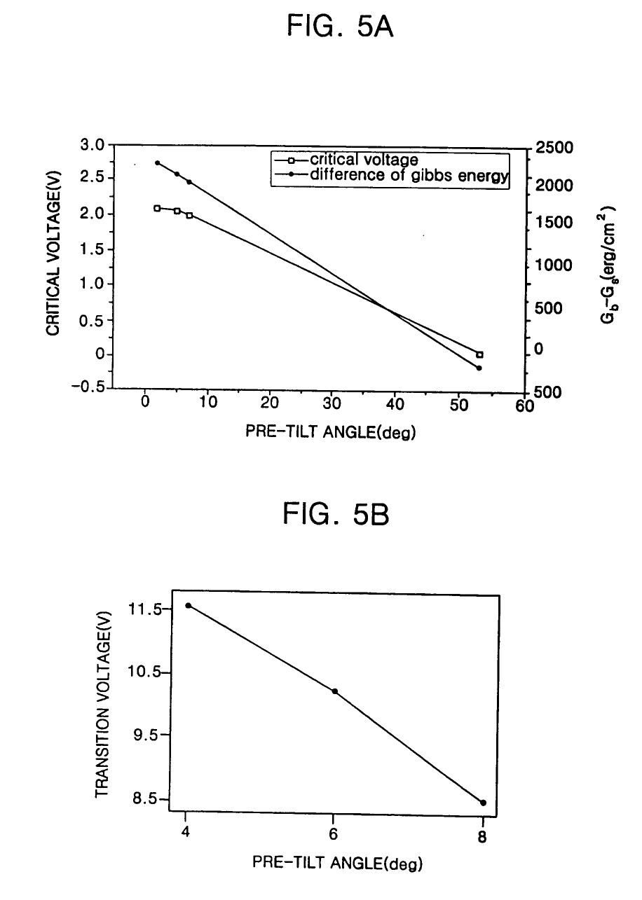

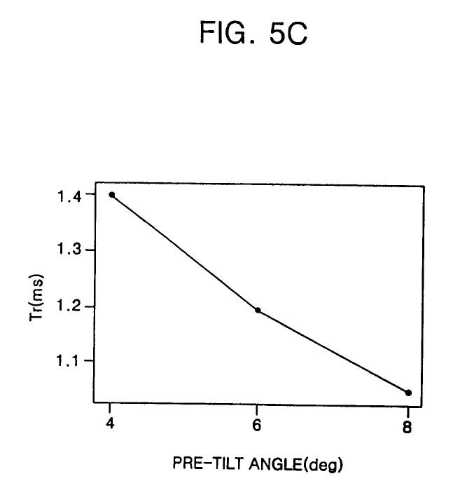

FIG. 5A to FIG. 5C are graphs for showing pre-tilt angle of liquid crystals according to one embodiment of the present invention. FIG. 5A illustrates a relation a Gibbs energy difference of bend phase and splay phase to critical voltage for pre-tilt angle, FIG. 5B illustrates a relation of transition voltage to pre-tilt angle, and FIG. 5C illustrates a relation of the Tr of the response time to the pre-tilt angle.

The pre-tilt angle means that alignment of liquid crystals is tilted in a certain angle to electrodes by characteristics of an alignment film in a liquid crystal display.

Referring to FIG. 5A, it can be seen that the more the pre-tilt angle is increased, the more the critical voltage is decreased to maintain bend phase. This is because the more a pre-tilt angle of OCB mode liquid crystals is increased, the more a Gibbs energy difference of bend phase and splay phase is decreased, and the value of critical voltage is decreased.

Referring to FIG. 5B, it can be seen that a transition voltage, that is the voltage required for transition of liquid crystals into bend phase from splay phase, is gradually decreased from 11.5 V to 8.5 V, according to increase of a pre-tilt angle of OCB mode liquid crystals from 4 degrees to 8 degrees. This means that the more the pre-tilt angle is increased, the more the response speed of a liquid crystal display device is increased.

Therefore, referring to FIG. 5A to FIG. 5C, it can be seen that the more the pre-tilt angle is increased, the more the critical voltage and the transition voltage are decreased, but the response speed is increased (response time is decreased). Furthermore, although a pre-tilt angle of 8 degrees is shown on graphs of the drawings, and a pre-tilt angle of more than 8 degrees is not shown on the graphs, it can be easily inferred from a tendency of the graphs that the transition voltage and Tr are tend to decrease according to increase of the pre-tilt angle. Accordingly, it is preferable to maintain the pre-tilt angle to 10 degrees or less since it is difficult to form an alignment film having a pre-tilt angle of 10 degrees or more in the process level and material stability aspects due to a process of uniformly aligning the alignment film all over the surface of the display. Although, it is clear that the more the pre-tilt angle is increased, the more excellent the characteristics of a liquid crystal display become. Therefore, the pre-tilt angle is preferably 4 to 10 degrees.

Furthermore, it is preferable that viscosity of the liquid crystals is maintained to 0.2 Pa or less, because the response time is too slow as 10 ms or more in the case the viscosity of the liquid crystals is 0.2 Pa or more, while the response time is too fast as 7 ms or less in the case the viscosity of the liquid crystals is 0.2 Pa or less.

Therefore, a liquid crystal display of the present invention obtains an effect of improving transition voltage, reliability and driving margin by optimizing birefringence, dielectric constant anisotropy, K11, K33 and viscosity of liquid crystals.

While the invention has been particularly shown and described with reference to embodiments thereof, it will be understood by those skilled in the art that the foregoing and other changes in form and details may be made therein without departing from the spirit and scope of the invention.

What is claimed is:

1. A liquid crystal display comprising:
a first substrate on which a first electrode is formed;
a second substrate facing the first substrate, on which a second electrode is formed; and
a liquid crystal layer filled between the first electrode and the second electrode and having a birefringence in the range of about 0.160 to 0.180.

2. The liquid crystal display according to claim 1, wherein the liquid crystal layer has a dielectric constant anisotropy in the range of about 12 or more.

3. The liquid crystal display according to claim 1, wherein the liquid crystal layer has a K11 of 14 or less and a K33 in the range of about 12 to 16, where K11 represents an elastic coefficient of a splay phase, and K33 represents an elastic coefficient of a bend phase.

4. The liquid crystal display according to claim 1, wherein the liquid crystal layer has a pre-tilt angle in the range of about 4 to 10 degrees.

5. The liquid crystal display according to claim 1, wherein the liquid crystal layer has a viscosity of 0.2 or less.

6. The liquid crystal display according to claim 1, wherein the liquid crystal layer has a dielectric constant anisotropy of 12 or more, a K11 of 14 or less, a K33 in the range of about 12 to 16 and a pre-tilt angle in the range of about 4 to 10 degrees, where K11 represents an elastic coefficient of a splay phase, and K33 represents an elastic coefficient of a bend phase.

7. The liquid crystal display according to claim 1, wherein the liquid crystal layer is an OCB mode liquid crystal layer.

8. The liquid crystal display according to claim 1, further comprising: a first alignment film formed on the first electrode; and a second alignment film formed on the second electrode.

9. The liquid crystal display according to claim 8, wherein the first alignment film and the second alignment film are rubbed in the same direction.

10. The liquid crystal display according to claim 1, further comprising: a first polarizer positioned on an outer part of the first substrate; and a biaxial compensation plate and a second polarizer positioned on an outer part of the second substrate.

11. The liquid crystal display according to claim 10, further comprising: a backlight unit positioned on an outer part of the first polarizer.

12. A liquid crystal display comprising:
a first substrate on which a first electrode is formed;
a second substrate facing the first substrate, on which a second electrode is formed; and
a liquid crystal layer filled between the first electrode and the second electrode and having a dielectric constant anisotropy of 12 or more.

13. The liquid crystal display according to claim 12, wherein the liquid crystal layer is an OCB mode liquid crystal layer.

14. The liquid crystal display according to claim 12, further comprising: a first alignment film formed on the first electrode; and a second alignment film formed on the second electrode.

15. The liquid crystal display according to claim 14, wherein the first alignment film and the second alignment film are rubbed in the same direction.

16. The liquid crystal display according to claim 12, further comprising: a first polarizer positioned on an outer part of the first substrate; and a biaxial compensation plate and a second polarizer positioned on an outer part of the second substrate.

17. The liquid crystal display according to claim 16, further comprising a backlight unit positioned on an outer part of the first polarizer.

18. A liquid crystal display comprising:
a first substrate on which a first electrode is formed;
a second substrate facing the first substrate, on which a second electrode is formed; and
a liquid crystal layer filled between the first electrode and the second electrode having a K11 of 14 or less and a K33 in the range of about 12 to 16, where K11 represents an elastic coefficient of a splay phase, and K33 represents an elastic coefficient of a bend phase.

19. The liquid crystal display according to claim 18, wherein the liquid crystal layer is an OCB mode liquid crystal layer.

20. The liquid crystal display according to claim 18, further comprising: a first alignment film formed on the first electrode; and a second alignment film formed on the second electrode.

21. The liquid crystal display according to claim 20, wherein the first alignment film and the second alignment film are rubbed in the same direction.

22. The liquid crystal display according to claim 18, further comprising: a first polarizer positioned on an outer part of the lower substrate; and a biaxial compensation plate and a second polarizer positioned on an outer part of the second substrate.

23. The liquid crystal display according to claim 22, further comprising: a backlight unit positioned on an outer part of the first polarizer.

24. A liquid crystal display comprising:
a first substrate on which a first electrode is formed;
a second substrate facing the lower substrate, on which a second electrode is formed; and
a liquid crystal layer filled between the first electrode and the second electrode and having a pre-tilt angle in the range of about 4 to 10 degrees.

25. The liquid crystal display according to claim 24, wherein the liquid crystal layer is an OCB mode liquid crystal layer.

26. The liquid crystal display according to claim 24, further comprising: a first alignment film formed on the first electrode; and a second alignment film formed on the second electrode.

27. The liquid crystal display according to claim 26, wherein the first alignment film and the second alignment film are rubbed in the same direction.

28. The liquid crystal display according to claim 24, further comprising: a first polarizer positioned on an outer part of the first substrate; and a biaxial compensation plate and a second polarizer positioned on an outer part of the second substrate.

29. The liquid crystal display according to claim 28, further comprising a backlight unit positioned on a lower part of the first polarizer.
